(19) United States
(12) Patent Application Publication
(10) Pub. No.: US 2026/0370483 A1
(43) Pub. Date: Nov. 19, 2026

(54) CLOUD SERVICE PASSWORD ROTATION

(71) Applicant: OPEN TEXT SA ULC, Halifax (CA)

(72) Inventors: Ning HU, Mississauga (CA); Matthew ROGERS, Milton (CA); Quang TRAN, Toronto (CA)

(21) Appl. No.: 19/206,600

(22) Filed: May 13, 2025

(51) Int. Cl. H04L 9/32; H04L 9/08

(52) U.S. Cl. CPC H04L 9/3226; H04L 9/0825; H04L 9/0869

(57) ABSTRACT

Systems and methods for rotating passwords in cloud-based backup systems are provided. Various embodiments of the present technology provide systems and methods for secure password rotation that ensure that a service provider never has access to unencrypted keys or unencrypted data, effectively eliminating internal threats and guaranteeing that only the customer has control over the data. This approach enhances security by keeping the encryption process entirely on the customer-side. Generally, data is encrypted using a customer-supplied password, ensuring only the customer can decrypt it. Embodiments of password rotation involve generating an encryption key, encrypting it with a customer key, and securely rotating the customer key using an agent installed at the customer’s location. Data is encrypted and decrypted at the client site using the encryption key, which is protected by the customer key.

### TECHNICAL FIELD

This disclosure relates generally to data storage systems. In particular, this disclosure relates to systems and methods for rotating passwords in cloud-based backup systems.

### BACKGROUND

Security in cloud backup systems is critical, especially regarding the protection of user data and passwords. Key challenges include ensuring that sensitive data and encryption keys are securely managed, particularly during processes like password rotation. When passwords are rotated, there is often a risk that data could be temporarily unencrypted as it is re-encrypted with a new key, creating a vulnerability if attackers were to gain access at that moment. Additionally, if a user’s password is exposed or processed on the data provider's infrastructure during a password rotation, it could be susceptible to insider threats or external breaches. For example, if the unencrypted password or key material is temporarily accessible at the provider’s site, it could be intercepted by unauthorized personnel or malicious actors, compromising data integrity and privacy.

In a typical password rotation process at a service provider's site, the system first decrypts the stored data using the current encryption key associated with the old password. Once decrypted, the data is momentarily unencrypted before being re-encrypted with a new encryption key generated based on the updated password. This brief period, during which the data is unencrypted, creates a temporary vulnerability, as the data could potentially be accessed if there are any security lapses or unauthorized access within the provider’s environment. Once re-encrypted with the new key, the data is securely stored again, but the rotation process requires rigorous controls to prevent exposure during this interim state. Furthermore, if the user's password or decryption key is handled at the provider’s site, it may be exposed to potential insider threats or breaches, risking both the user’s data security and privacy.

Implementing password rotation securely requires careful management, ensuring passwords are not only encrypted end-to-end but also rotated on the client side to prevent exposure at any stage. Without these safeguards, cloud backup systems remain at risk of various attack vectors, particularly during critical operations like password changes or data re-encryption.

### SUMMARY

Systems and methods for rotating passwords in cloud-based backup systems are described that, in some embodiments, comprise, at a local client environment, generating an envelope, the envelope contents including a random key encrypted using a first password. At a service provider environment, client data is stored, encrypted using the random key. A password rotation is initiated by: receiving, from a user at the local client environment, a new password; encrypting, at the local client environment, the new password using an agent public key; making an API call to a service of the backup service provider, the API call including the encrypted new password as a parameter; making a call from the service of the service provider to an agent running at the local client environment for a password rotation; and generating, by the agent running at the local client environment, a new envelope including the random key.

Embodiments of the present invention also include computer-readable storage media containing sets of instructions to cause one or more processors to perform the methods, variations of the methods, and other operations described herein.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE FIGURES

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 is a block diagram of an exemplary architecture for facilitating a secure password rotation.

FIG. 2 is a sequence diagram illustrating a process that occurs upon the installation of an agent at a client device for facilitating password rotations.

FIG. 3 is a sequence diagram illustrating processes relating to a password rotation.

FIG. 4 is a flow chart illustrating one example of a password rotation process.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present disclosure describes a system and method relating to password rotation to enhance data security in a data center, such as a cloud-based storage service. Generally, data is encrypted using a customer-supplied password, ensuring only the customer can decrypt it. The process discussed below involves generating a random key, encrypting it with a customer key derived from the customer-supplied password, and securely rotating it using an agent installed at the customer’s location. This method ensures that the service provider never has access to the unencrypted key, effectively eliminating internal threats and guaranteeing that only the customer has control over the data. This approach enhances security by keeping the encryption process entirely on the customer-side.

In this password rotation scheme for a cloud-based backup service provider, a dedicated agent is installed at the customer’s location to manage encryption locally and ensure data security. During setup, the agent generates a unique backup encryption key, which may be a randomly generated key, which it then uses to encrypt the customer’s data before any data leaves the customer’s environment. This random encryption key is itself encrypted using the customer’s password, creating a secure, password-protected key that is then shared with a service at the service provider’s location. Meanwhile, the encrypted customer data is stored remotely at the provider’s site, while both the unencrypted data and the customer’s unencrypted password remain secure and unseen by the provider. This setup ensures that only the customer, using their password, can decrypt the data, minimizing risk by keeping sensitive information inaccessible to the service provider.

The password rotation techniques described herein provide various advantages over conventional systems. For example, as mentioned above, in conventional systems, unencrypted customer data and/or passwords may temporarily be stored in memory at a backup service, creating a vulnerability, if attackers were to gain access at that moment. In addition, in a typical password rotation process, the system first decrypts the stored data using the current encryption key associated with the old password, and then re-encrypts the data using a new password. Even if this is done securely, this process requires a lot of time and resources decrypting and re-encrypting data. Further, if the decrypting and re-encrypting of data is performed at a client’s site, the re-encrypted data has to be re-uploaded to the service provider. Thus, by using the techniques described herein, the performance and efficiency of the overall system is greatly improved, requiring less resources and less time to achieve a password rotation.

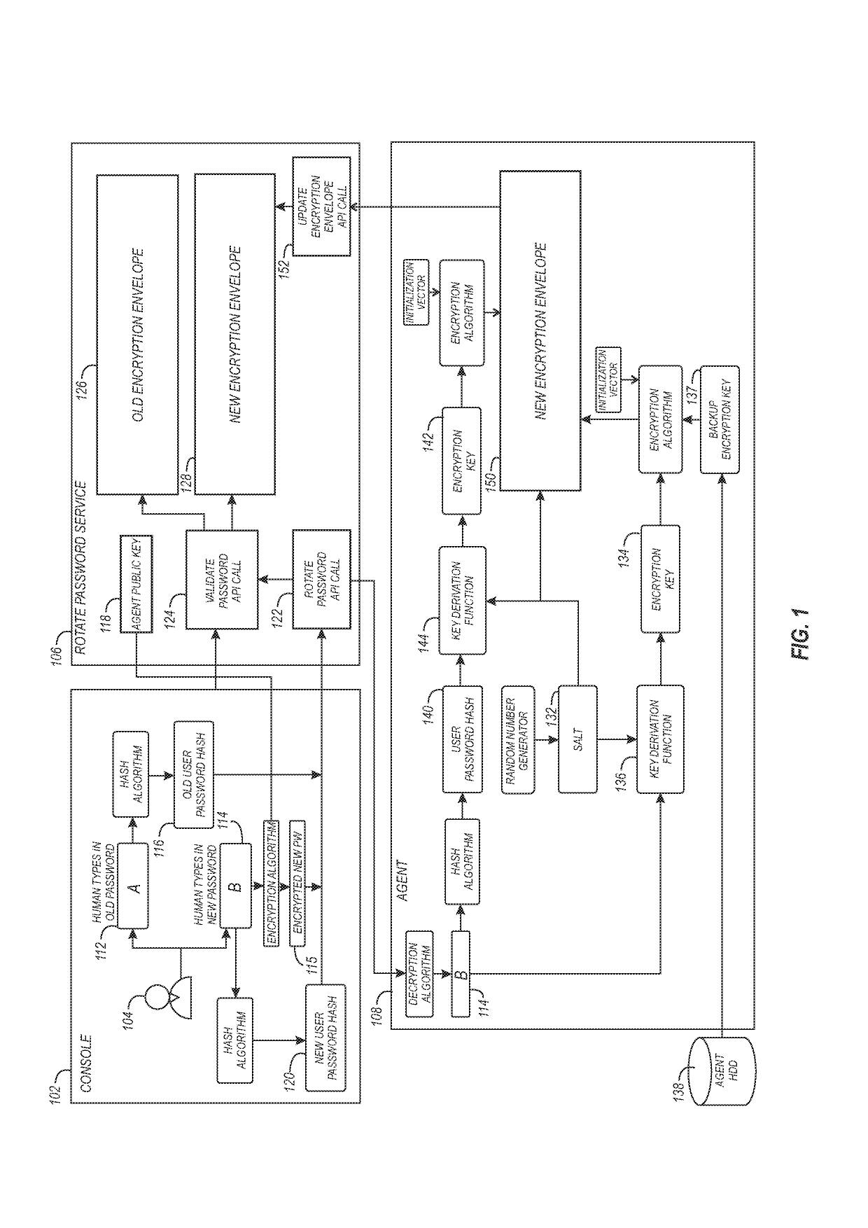

FIG. 1 is a block diagram of an exemplary architecture for facilitating a secure password rotation, in one embodiment, as described above. In this example, a console 102 is provided, where a user 104 (e.g., an administrator) can rotate a customer password. In some embodiments, the console runs on a web browser, although other embodiments are possible, as one skilled in the art would understand. Generally, this password rotation process involves re-encrypting the backup encryption key (i.e., the unique random key created at installation of the agent) and user password hash and storing them in a rotate password service 106, which, in this embodiment, is a service of a data center, or other data storage service. One purpose of having a rotate password service relates to a disaster recovery workflow. For example, if the agent machine is destroyed, the customer can set up a new machine and a new agent, and will be able to restore the backed up data as long as they have the customer-supplied password. As is evident from the description below, the password rotation process occurs entirely within the agent 108, running at a local client environment. In the described arrangement, the cloud runtime (data center, data storage service, etc.) is not able to have access to either the unencrypted customer data, nor the customer’s unencrypted password.

At the console 102, a user 104 (e.g., an administrator, or other user) enters the existing password 112 (old user password “A”). A rotate password user interface (UI) then calculates the hash 116 of the old password 112. The rotate password UI also gets the agent public key 118 of the agent from rotate password service 106, and encrypts the new password 114 (new user password “B”) with the agent public key 118 (e.g., via any desired public-key encryption algorithm, such as ECC, DH, RSA, etc.), resulting in the encrypted new password 115. The hash 120 of the new password 114 is also calculated. Note that, throughout this description, references are made to hash algorithms. Any desired hash algorithm could be used, as one skilled in the art would understand, such as algorithms based on MD5, SH-1, SHA-2, SHA-3, BLAKE, RIPEMD, etc., with any desired hash length output,

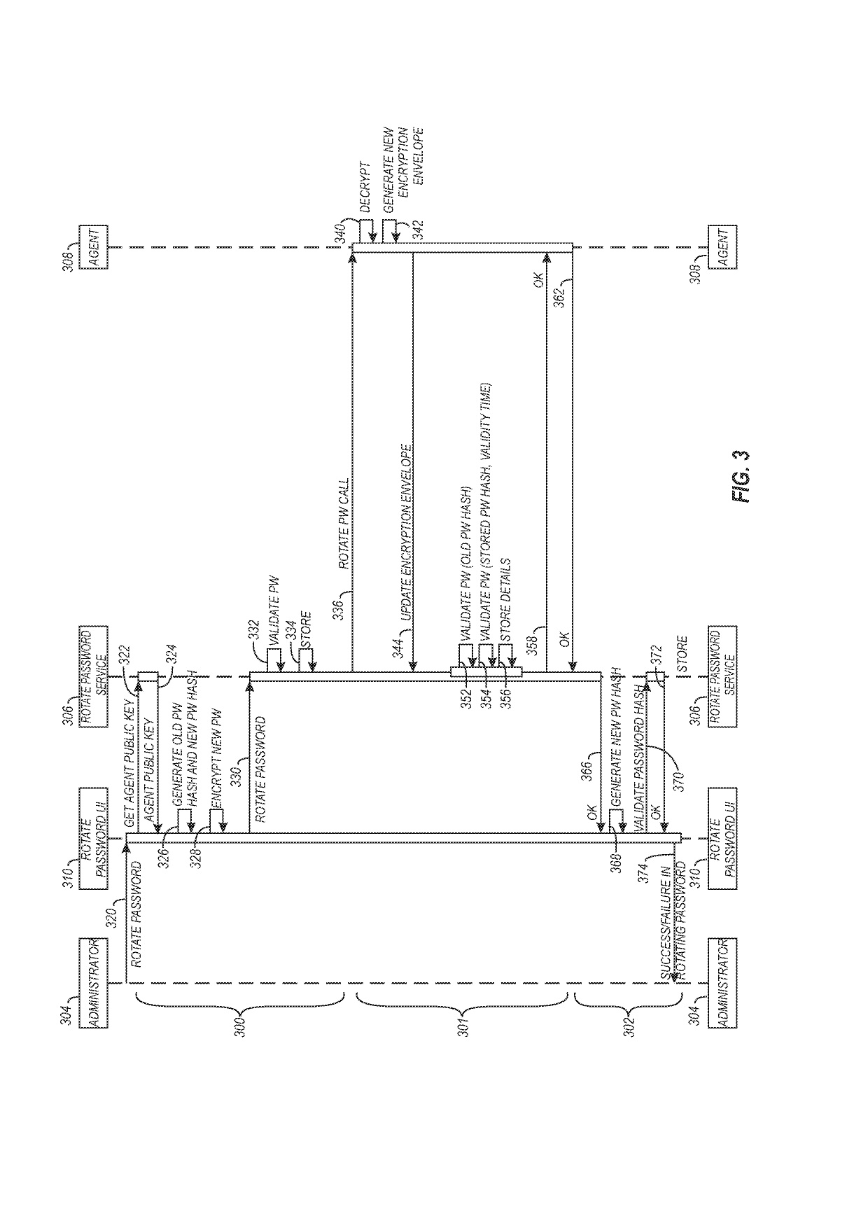

The console 102 then makes a rotate password API call 122 (Rotate Password API Call) to the rotate password service 106 with the old password hash 116, new password hash 120, and the encrypted new password as parameters to the API call (discussed in detail below, with respect to FIG. 3). For the API call 122, any desired protocol may be used, as one skilled in the art would understand. At the rotate password service 106, the old password hash is validated at 124 to ensure that the user knows the old password. In some embodiments, validation includes validating that the old password hash is correct (i.e., it matches the stored old password hash). The following steps assume a successful validation. Any password rotation that is not validated is rejected. The new password hash 120 is also stored for future validations, along with, in some embodiments, a validity period which is less than a timeout period (i.e., 25 seconds if the timeout is 30 seconds). In some embodiments, a password rotation is authorized to happen within X seconds before a timeout (e.g., 30 seconds, etc.). This ensures that a password rotation happens either before an initial request from the user times out, or not at all.

FIG. 1 shows, at the rotate password service 106, an old encryption envelope 126 and a new encryption envelope 128, each of which includes an encrypted backup encryption key, an encrypted user password hash, and a salt (a random piece of data added to the respective password before it is hashed, to protect against certain types of attacks, as one skilled in the art would understand). Note that it is desired to not clobber (overwrite) the old password hash, in case of a failed validation. After validation, a call (using any desired protocol) to the agent 108 is made to rotate the password. The agent maintains a hash of the current user password, and the agent checks that the rotation request’s original password hash matches the hash it has on record.

As mentioned above, the API call 122 includes the old password hash 116, new password hash 120, and the encrypted new password 115 as parameters. These three parameters are sent to the Agent 108 to perform the actual password rotation in the customer’s environment. On the agent, the old password hash is validated. A random salt 132 of a desired size is generated (e.g., via a cryptographically secure random number generator such as /dev/urandom (Unix), SecureRandom (Java), secrets module (Python), OpenSSL’s Rand_bytes, BCryptGenRandom (Windows), etc.). The salt 132 is combined with the new password 114 (which is decrypted at the agent via a decryption algorithm using the agent private key) to generate an encryption key 134 using, in some embodiments, a key derivation function 136 (e.g., PBKDF1, PBKDF2, Argon2, Scrypt, etc. using a desired number of iterations, e.g., per OWASP recommendations).

Next, the backup encryption key 137 (stored in and read from Agent HDD 138 (e.g., the agent local machine) is encrypted (e.g., using any desired encryption algorithm with any desired key length, e.g., symmetric encryption algorithms based on DES, AES, 3DES, Blowfish, RC6, ChaCha20, etc.) using the new encryption key 134 (resulting in an encrypted backup encryption key). The hash 140 of the new user password 114 is calculated using a desired hash algorithm. A password hash encryption key 142 is created using the random salt 132 (described above) and the hash 140 of the new user password 114 (e.g., using key derivation function 144). Next, the hash 140 of the user password 114 is encrypted using the password hash encryption key 142 (e.g., using a desired encryption algorithm). The encrypted backup encryption key, encrypted user password hash, and salt (comprising the new encryption envelope 150) are provided to and stored in rotate password service 106 via update encryption envelope API call 152.

Next, the rotate password service 106 validates (responsive to the update encryption call 152) that the new password hash matches the one stored, as well as complies with the specified validity period (see the timeout period, discussed above). After this validation, the rotate password service 106 responds to the agent API call 152 with an OK (e.g., see steps 344-358 in FIG. 3, discussed below), and the agent 108 then updates its current copy of the password hash with the new password hash, and responds to the rotate API call 122 that the password rotation is complete. Next, the rotate password UI validates (124) the new password hash against the rotate password service 106 to make sure the password has successfully or unsuccessfully been rotated, and sends back the response to the user 104.

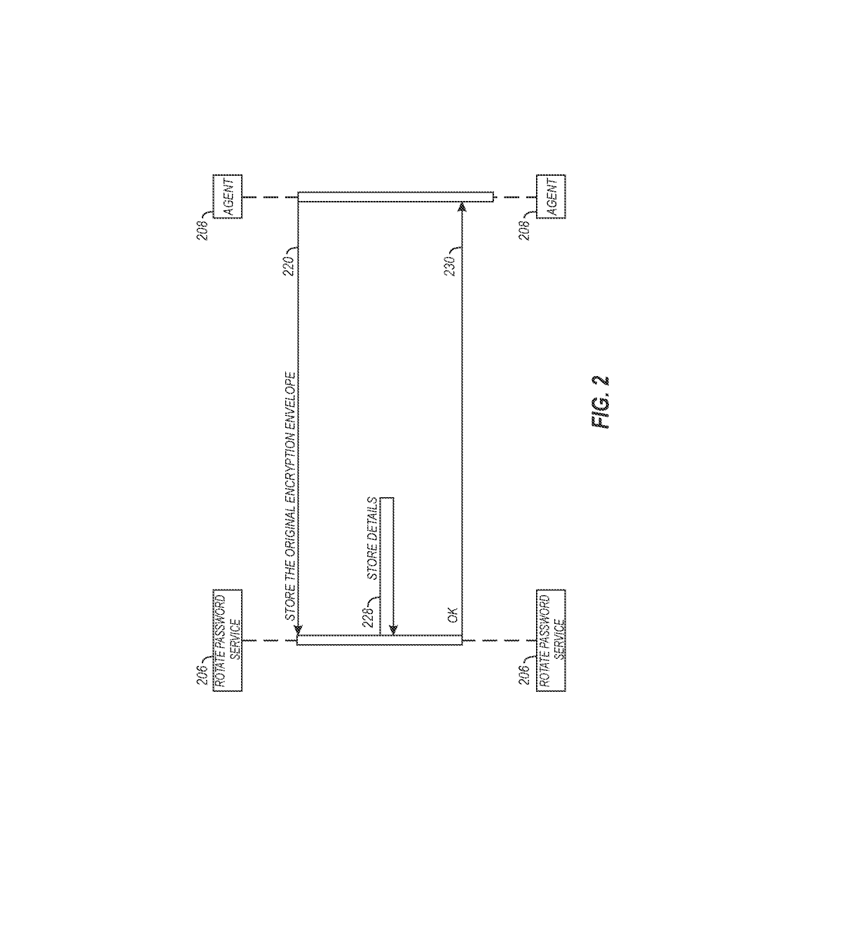

FIGS. 2 and 3 are sequence diagrams that further clarify the process described above. FIG. 2 is a sequence diagram illustrating a process that occurs upon the installation of the agent at a client device.

In FIG. 2, upon the installation of the agent 208 on a client device, a device backup encryption key (i.e., a random key) is generated and stored. Next, the agent 208 sends a message (220) to the rotate password service 206 to store the original encryption envelope. Parameters sent to the rotate password service 206 may include the encrypted backup encryption key, the encrypted user password hash, and salt. For example, referring to FIG. 1, the old and new encryption envelopes at the rotate password service 106 each include an encrypted backup encryption key, encrypted user password hashes, and a salt. The message may also include the device ID, authorization information, and agent public key. The rotate password service 206 then stores the details (228), including the encrypted backup encryption key, the encrypted user password hash, the salt, the device ID, authorization information, and agent public key. In response, the rotate password service 206 sends an OK message (230) to the agent 208.

FIG. 3 is a sequence diagram illustrating processes relating to a password rotation, as described above with respect to FIG. 1. A first portion 300 of FIG. 3 shows a process for starting a password rotation. A second portion 301 shows a process for password rotation with respect to the agent. A third portion 302 shows a process for finalizing and validating a password rotation.

At 320, an administrator 304 initiates a password rotation at a user interface of the console and enters the old password and a new password. The rotate password UI 310 then requests (322) the agent public key from the rotate password service 306. The rotate password service 306 responds (324) with the agent public key. The rotate password UI 310 then generates (326) the old password hash and the new password hash, as described above with respect to FIG. 1. Next the rotate password UI 310 encrypts (328) the new password, as also described above.

At 330, the rotate password UI 310 makes a rotate password API call with the old password hash, new password hash, and the encrypted new password as parameters. At the rotate password service 306, the API call is validated (332), as described in detail above, by comparing the old password hash with an existing old password hash. At 334, the new password hash and validity information are stored for future validations. At 336, a rotate password call is made to the agent 308.

At the agent 308, the encrypted new password is decrypted (340) and a new encryption envelope is generated. The new encryption envelope includes the new encrypted backup encryption key generated (342) by encrypting the backup encryption key using the new password encryption hash (see 134 in FIG. 1). The encryption envelope also includes the encrypted new password hash, and the new salt).

At 344, the agent 308 sends a message to update the encryption envelope at the rotate password service 306 by encrypting the backup encryption key using a key derived from the new password hash. This message includes the old password hash, encrypted backup key, the new password hash, and salt as parameters. The rotate password service 306 then updates the encryption envelope (e.g., via API call 152 discussed with respect to FIG. 1).

At the rotate password service 306, the old password hash is validated at 352. At 354, the new password hash is validated, as well as the validity information (e.g., validity time). At 356, the encrypted backup encryption key, encrypted user password hash, salt, device ID, authorization information, and agent public key are stored by the rotate password service 306. The rotate password service 306 then sends an OK message (358) back to the agent 308. The agent 308 then sends an OK message (362) back to the rotate password service 306, in response to the rotate call 336.

At 366, the rotate password service 306 sends an OK message back to the rotate password UI 310. The rotate password UI 310 then regenerates the new password hash (368) and revalidates the new password hash (370) with the rotate password service 306. The rotate password service 306 replies to the rotate password UI 310 with an OK message (372). Finally, the rotate password UI 310 replies to the administrator 304 with a password rotation success (374).

Once the password has been rotated, the backup/storage system continues operating as before, encrypting and/or decrypting data using the same encryption key, although the encryption key is now encrypted with the new password, thus making the old password obsolete.

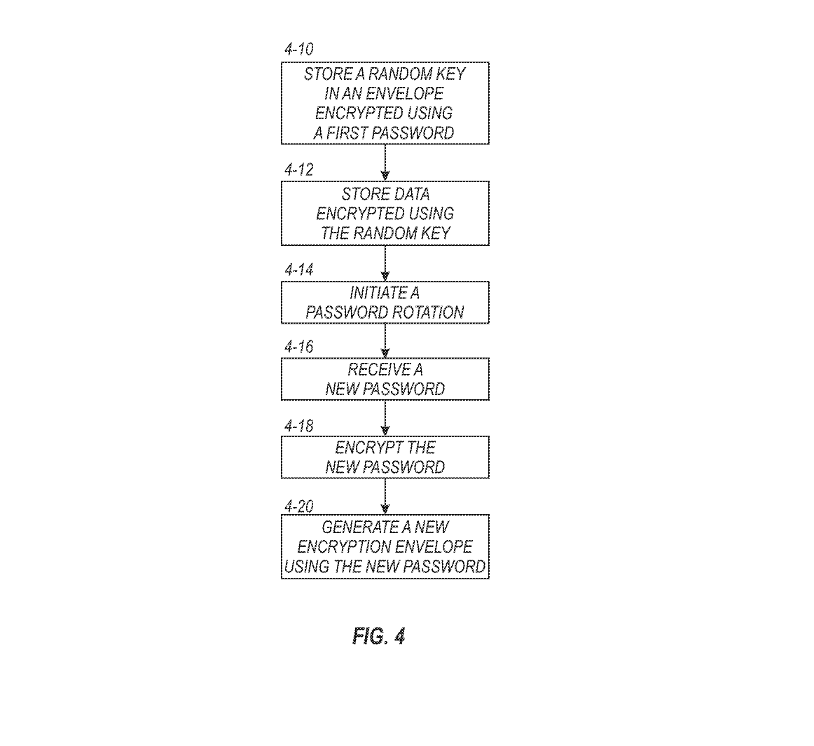

FIG. 4 is a flowchart illustrating one embodiment of a process for rotating a password as described above. This embodiment will be described in the context of a backup service provider that stores encrypted client data. Other environments and contexts are also possible, as one skilled in the art would understand. As described above with respect to FIG. 2, upon the installation of the agent on a client device, a backup encryption key is randomly generated. The random key is stored in an encryption envelope (step 4-10). The random key is encrypted using a first (old) password.

In some embodiments, client data is encrypted at the client’s location, using the random key. The encrypted data, which is encrypted using the random key, is then stored (step 4-12), in some embodiments, at the backup service provider’s location. At step 4-14, a password rotation is initiated. At a user interface, a user enters the old password and a new password (step 4-16). The new password is then encrypted (step 4-18), for example, using the agent public key. Finally, a new encryption envelope is generated, using the new password (step 4-20). Like the previous encryption envelope, the new encryption envelope contains the random key. Thereafter, the client data is still encrypted and decrypted using the random key, but access to the random key is now protected by the new password, making the old password obsolete, without requiring decrypting and re-encrypting of the client data with a new password.

Although the invention has been described with respect to specific embodiments thereof, these embodiments are merely illustrative, and not restrictive of the invention as a whole. Rather, the description is intended to describe illustrative embodiments, features and functions in order to provide a person of ordinary skill in the art context to understand the invention without limiting the invention to any particularly described embodiment, feature or function, including any such embodiment feature or function described in the Abstract or Summary. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Software implementing embodiments disclosed herein may be implemented in suitable computer-executable instructions that may reside on a computer-readable storage medium. Within this disclosure, the term “computer-readable storage medium” encompasses all types of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, hosted or cloud-based storage, and other appropriate computer memories and data storage devices.

Those skilled in the relevant art will appreciate that the invention can be implemented or practiced with other computer system configurations including, without limitation, multi-processor systems, network devices, mini-computers, mainframe computers, data processors, and the like. The invention can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks).

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. At least portions of the functionalities or processes described herein can be implemented in suitable computer-executable instructions. The computer-executable instructions may reside on a computer readable medium, hardware circuitry or the like, or any combination thereof.

Any suitable programming language can be used to implement the routines, methods or programs of embodiments of the invention described herein, including C, C++, Java, JavaScript, HTML, or any other programming or scripting code, etc. Different programming techniques can be employed such as procedural or object oriented. Other software/hardware/network architectures may be used. Communications between computers implementing embodiments can be accomplished using any electronic, optical, radio frequency signals, or other suitable methods and tools of communication in compliance with known network protocols.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Generally then, although the invention has been described with respect to specific embodiments thereof, these embodiments are merely illustrative, and not restrictive of the invention. Rather, the description is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

What is claimed is:

1. A method of password rotation for a backup service provider, the method comprising:
at a local client environment, generating an envelope, the envelope contents including a random key encrypted using a first password;
at a service provider environment, storing client data encrypted using the random key;
initiating a password rotation by:
receiving, from a user at the local client environment, a new password;
encrypting, at the local client environment, the new password using an agent public key;
making an API call to a service of the backup service provider, the API call including the encrypted new password as a parameter;
making a call from the service of the service provider to an agent running at the local client environment for a password rotation; and
generating, by the agent running at the local client environment, a new envelope including the random key.

2. The method of claim 1, wherein the API call includes as a parameter a hash of the first password, a hash of the new password, and an encrypted version of the new password, the method further comprising validating information in the API call to the service by comparing the received hash of the first password with a stored hash of the first password.

3. The method of claim 2, further comprising storing the hash of the new password for future communication verifications.

4. The method of claim 2, wherein generating the new envelope further comprises:
decrypting the encrypted new password; and
encrypting the random key using the new password.

5. The method of claim 4, further comprising combining the new password with a salt to generate an encryption key, wherein the random key is encrypted using the encryption key.

6. The method of claim 5, wherein the new envelope includes the encrypted random key, an encrypted hash of the new password, and the salt.

7. The method of claim 2, further comprising:
responsive to the API call, setting a validation time period;
receiving, by the service of the service provider from the agent, validation that the password rotation is complete; and
determining that the password rotation has occurred within the validation time period.

8. The method of claim 1, further comprising providing the new envelope to the service of the service provider.

9. The method of claim 8, further comprising validating, by the service of the service provider, the new envelope by comparing a new password hash in the new envelope with a stored new password hash.

10. The method of claim 1, wherein, subsequent to the password rotation, the method further comprises:
encrypting, by the agent, new data using the random key included in the new envelope; and
storing the encrypted new data at the service provider environment.

11. A system of password rotation for a backup service provider, the system comprising:
a processor; and
a non-transitory computer readable medium storing instructions translatable by the processor, the instructions when translated by the processor perform:
at a local client environment, generating an envelope, the envelope contents including a random key encrypted using a first password;
at a service provider environment, storing client data encrypted using the random key;
initiating a password rotation by:
receiving, from a user at the local client environment, a new password;
encrypting, at the local client environment, the new password using an agent public key;
making an API call to a service of the backup service provider, the API call including the encrypted new password as a parameter;
making a call from the service of the service provider to an agent running at the local client environment for a password rotation; and
generating, by the agent running at the local client environment, a new envelope including the random key.

12. The system of claim 10, wherein the API call includes as a parameter a hash of the first password, a hash of the new password, and an encrypted version of the new password, the method further comprising validating information in the API call to the service by comparing the received hash of the first password with a stored hash of the first password.

13. The system of claim 12, further comprising storing the hash of the new password for future communication verifications.

14. The system of claim 12, wherein generating the new envelope further comprises:
decrypting the encrypted new password; and
encrypting the random key using the new password.

15. The system of claim 14, further comprising combining the new password with a salt to generate an encryption key, wherein the random key is encrypted using the encryption key.

16. The system of claim 15, wherein the new envelope includes the encrypted random key, an encrypted hash of the new password, and the salt.

17. The system of claim 12, further comprising:
responsive to the API call, setting a validation time period;
receiving, by the service of the service provider from the agent, validation that the password rotation is complete; and
determining that the password rotation has occurred within the validation time period.

18. The method of claim 11, further comprising providing the new envelope to the service of the service provider.

19. The system of claim 18, further comprising validating, by the service of the service provider, the new envelope by comparing a new password hash in the new envelope with a stored new password hash.

20. The system of claim 10, wherein, subsequent to the password rotation, the method further comprises:
encrypting, by the agent, new data using the random key included in the new envelope; and
storing the encrypted new data at the service provider environment.
